(19) United States
(12) Patent Application Publication
(10) Pub. No.: US 2008/0020209 A1
(43) Pub. Date: Jan. 24, 2008

(54) Optical material and method for making the same

(75) Inventor: Ching-Chou Chen, Yung-Kang City (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: Mildex Optical Inc., Yong-An Township (TW)

(21) Appl. No.: 11/488,098

(22) Filed: Jul. 18, 2006

(51) Int. Cl. B32B 27/36

(52) U.S. Cl. 428/412

(57) ABSTRACT

An optical material includes a substrate, and an optical unit formed on the substrate and including a base layer of a base polymer, an optical layer of a polymer, and a complex layer disposed between the base layer and the optical layer. The complex layer is formed by the following steps: contacting one side of the base layer with a solution containing a monomeric compound of the polymer such that the monomeric compound penetrates into the base layer so as to form a penetrated region in the base layer and that a polymerizable layer of the monomeric compound of the polymer is formed on the penetrated region; and polymerizing the monomeric compound of the polymerizable layer and the monomeric compound in the penetrated region so as to form the optical layer and the complex layer, respectively. A method for making the optical material is also disclosed.

### BACKGROUND OF THE INVENTION

1. Field of the Invention

This invention relates to an optical material and a method for making the same, more particularly to an optical material with improved bonding strength between layers and a method for making the same.

2. Description of the Related Art

Referring to FIG. 1, a conventional optical material 1 includes a substrate 11 and an optical unit 12 containing a supporting layer 121 bonded to the substrate 11, an optical layer 122 formed on the supporting layer 121, and an optional hard coating 123 formed on the optical layer 122.

In general, the optical material 1 is formed by providing the supporting layer 121 of a high molecular transparent film, forming the optical layer 122 on the supporting layer 121 so as to obtain a two-layered structure, shaping the two-layered structure in a preforming machine, forming the substrate 11 by injection molding a high molecular material onto the supporting layer 121, and forming a hard coating 123 on the optical layer 122 by coating a monomer solution of siloxane or methylacrylic acid on the optical layer 122 followed by heating or irradiating the coated monomer solution. The high molecular transparent film for the supporting layer 121 is a film having polarizing property, for example, polyvinyl alcohol (PVA) polarizer film, polyethylene terephthalate (PET) polarizer film, polyester polarizer film, etc.. The optical layer 122 includes photochromic dye. Such optical material 1 with polarizing and photochromic properties can prevent injury to human eyes due to glare and high energy light, and is commonly used in plano lenses, single vision lenses, bifocal lenses, progressive lenses, visors, goggles, windows and doors. The hard coating 123 is used to protect the optical layer 122 and may be dispensed with depending on the intended use. The optical material 1 can also include another optical unit on the other side of the substrate 11 based on actual requirements.

The above conventional optical material 1 has a disadvantage of easy delamination between the layers so that the optical material 1 has poor resistance to weather and has a short service life. To overcome this drawback, several methods, such as plasma surface modification, adhesive film adhesion, and surface roughness, have been proposed. However, the effect achieved thereby is undesirable and a side effect may occur.

For example, U.S. Pat. No. 6,759,090B2 discloses a method for improving adhesion of an optical coating to a polarizer film incorporated onto an optical-quality plastic construct. The method includes: forming grooves having a substantially uniform direction on a surface of the polarizer film (i.e., uniform physical roughening process); exposing the roughened surface of the polarizer film to a caustic solution (e.g., 10% NaOH); dipping the film in a solution comprised of the optical coating; and withdrawing the film in a direction substantially perpendicular to the grooves. Although the delamination effect can be alleviated, the optical material has a low optical quality because of the light diffusion effect due to roughness of the surface of the polarizer film.

Therefore, there is a need in the art to provide an optical material that has a high optical quality without layer delamination.

### SUMMARY OF THE INVENTION

Therefore, the object of the present invention is to provide an optical material and a method for making the same that can overcome the aforesaid drawback of the prior art.

According to one aspect of this invention, an optical material includes: a substrate having an upper surface and a lower surface; and an optical unit formed on the upper surface of the substrate and including a base layer of a base polymer, an optical layer of a polymer, and a complex layer disposed between the base layer and the optical layer. The complex layer is formed by the following steps: contacting one side of the base layer with a solution containing a monomeric compound of the polymer such that the monomeric compound of the polymer penetrates into the base layer so as to form a penetrated region in the base layer and such that the monomeric compound of the polymer forms into a polymerizable layer on the penetrated region of the base layer; and polymerizing the monomeric compound of the polymerizable layer and the monomeric compound in the penetrated region of the base layer so as to form the penetrated region into the complex layer and the polymerizable layer into the optical layer.

According to another aspect of this invention, a method for making an optical material comprises the steps of: (a) providing a base layer made of a base polymer and having an upper side and a lower side; (b) contacting the upper side of the base layer with a solution containing a monomeric compound of a polymer such that the monomeric compound of the polymer penetrates into the base layer so as to form a penetrated region in the base layer and such that the monomeric compound of the polymer forms into a polymerizable layer on the penetrated region of the base layer; and (c) polymerizing the monomeric compound of the polymerizable layer and the monomeric compound in the penetrated region of the base layer so as to form the penetrated region into a complex layer and the polymerizable layer into an optical layer.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic view of a conventional optical material;

FIG. 2 is a schematic view of the first preferred embodiment of an optical material according to this invention;

FIG. 3 is a schematic view of the second preferred embodiment of an optical material according to this invention;

FIG. 4 is a schematic view of the third preferred embodiment of an optical material according to this invention; and

FIG. 5 is a schematic view of the fourth preferred embodiment of an optical material according to this invention.

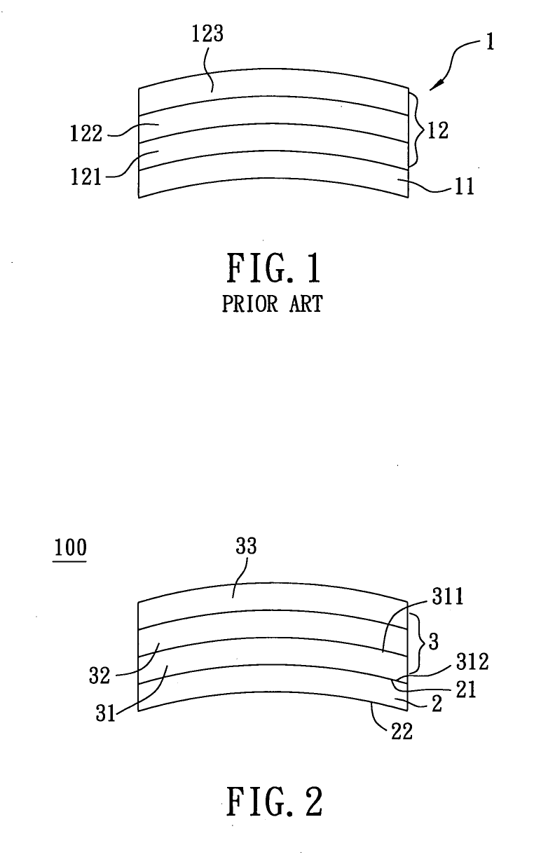

### DETAILED DESCRIPTION OF THE PREFERRED EMBODIMENTS

Before the present invention is described in greater detail, it should be noted that same reference numerals have been used to denote like elements throughout the specification.

Referring to FIG. 2, the first preferred embodiment of an optical material 100 according to the present invention is shown to include a substrate 2 having an upper surface 21 and a lower surface 22; and a first optical unit 3 formed on the upper surface 21 of the substrate 2. The first optical unit 3 includes a base layer 31 of abase polymer, a first optical layer 33 of a first polymer, and a first complex layer 32 disposed between the base layer 31 and the first optical layer 33.

The optical material 100 in this embodiment is made by: (a) providing a base layer 31 having an upper side 311 and a lower side 312; (b) contacting the upper side 311 of the base layer 31 with a first solution containing a monomeric compound of a first polymer such that the monomeric compound of the first polymer penetrates into the base layer 31 so as to form a first penetrated region in the base layer 31 and such that the monomeric compound of the first polymer forms into a first polymerizable layer on the first penetrated region of the base layer 31; (c) polymerizing the monomeric compound of the first polymerizable layer and the monomeric compound in the first penetrated region of the base layer 31 using ultraviolet light or heat so as to form the first penetrated region into the first complex layer 32 and the first polymerizable layer into the first optical layer 33 such that a first optical unit 3 is obtained; and (d) bonding a substrate 2 to the lower side 312 of the base layer 31 of the first optical unit 3 by injection molding.

The term “monomeric compound” described hereinafter refers to a precursor of a polymer including a monomer or a prepolymer of the polymer. Preferably, the monomeric compound of the first polymer is a prepolymer having a molecular weight ranging from 50 to 5,000, and more preferably, from 50 to 500.

The first complex layer 32 thus formed includes the base polymer and the first polymer, and is formed by polymerizing the monomeric compound of the first polymer after the monomeric compound penetrates into the base polymer of the base layer 31. With such complex layer 32, the adhesion between the base layer 31 and the first optical layer 33 is improved.

In this invention, the substrate 2 is made of a substrate polymer selected from the group consisting of polycarbonate (PC), polymethylmethacrylate (PMMA), polysulfone, polystyrene (PS), polyurethane (PU), m-cycloolefin copolymer (m-COC), transparent nylon, allyl methacrylate, diethylene glycol bis allylcarbonate (e.g., CR-39), polycarbonate/polyester alloy (e.g., xylex™ available from GE company, USA), and a resin having a refractive index greater than 1.56 (i.e., medium index resin and high index resin). More preferably, the substrate 2 is made of a substrate polymer selected from the group consisting of polycarbonate, polymethylmethacrylate, polystyrene, polyurethane, m-cycloolefin copolymer, polycarbonate/polyester alloy, and transparent nylon. Since polycarbonate/polyester alloy has a low photoelastic stress and a low injecting temperature, it is more suited for the substrate 2 than the others.

Preferably, the base layer 31 exhibits polarizing property and is made of a base polymer selected from the group consisting of polyvinyl alcohol (PVA), polyethylene terephthalate (PET), polyester, polyacrylate, polycarbonate (PC), polyurethane (PU), cellulose ester, cycloolefin copolymer, polycarbonate/polyester alloy, and combinations thereof.

The first polymer is selected from the group consisting of ethylene glycol bismethacrylate polymer, ethoxylated phenol bismethacrylate polymer, urethane acrylate polymer, polythiourethane polymer, cellulose acetate butyrate, styrene polymer, polyurethane, copoly(styrene-methyl methacrylate) polymer, and combinations thereof. More preferably, the first polymer is selected from the group consisting of ethylene glycol bismethacrylate polymer and polyurethane. The amount of the first polymer is relevant to the layer thickness of the first optical layer 33 and varies based on the intended use of the optical material 100.

A first solvent included in the first solution is used to dissolve the first polymer and to permit swelling of the base layer 31. Preferably, the first solvent suitable for this invention has high polarity, and is selected from the group including, but not limited, tetrahydrofuran (THF), toluene, hexanone, ether for dissolving polymers, etc..

The first solution further includes a first dye such that the first dye remains in the first polymerizable layer. The first dye is a photochromic dye or a photo-absorbing dye such that the optical material 100 is capable of changing color with the extrinsic environment and is further capable of preventing injury to the human eyes. The first dye suitable for this invention includes, for example, blue photochromic dye, Reversacol™ photochromic dyes available from James Company, anti-infrared photo-absorbing dye, anti-UV photo-absorbing dye, melanin dye, and dichroic dyes. The amount of the first dye preferably ranges from 0 to 15 wt % of the first polymer, more preferably, from 4 to 8 wt %, and most preferably, from 5 to 6 wt %, when the first dye is a photochromic dye.

The first solution has a solid content less than 70 wt %, preferably, ranging from 4 to 50 wt %, and more preferably, from 15 to 35 wt %. In addition, the first solution has a viscosity ranging from 1 CPS to 150 CPS, and preferably, from 20 to 40 CPS.

In this method, the first solvent permits penetration of the first monomeric compound of the first polymer into the base layer 31. The penetration of the first monomeric compound of the first polymer can be conducted by directly pouring the first solution onto the upper side 311 of the base layer 31, or spreading the first solution on the upper side 311 of the base layer 31 using a roller or an appropriate device (e.g., a duckbill nozzle). The layer thickness of the first polymerizable layer can be controlled by the pouring rate of the first solution, the solid content and the amount of the first solution, and the spreading speed of the device. The pouring rate ranges from 1 to 100 mm/sec, and preferably from 10 to 20 mm/sec. When using the duckbill nozzle, the spreading speed is set at 15 mm/sec. After spreading and immersing for 1 to 15 minutes, the base layer 31 and the first polymerizable layer are treated by ultraviolet light or heat.

If the optical material 100 is to be used as an ophthalmic lens, the method further includes a step of (e) shaping the first optical unit 3 into a desired shape before the bonding step (d). The shaping conditions can vary based on actual requirements.

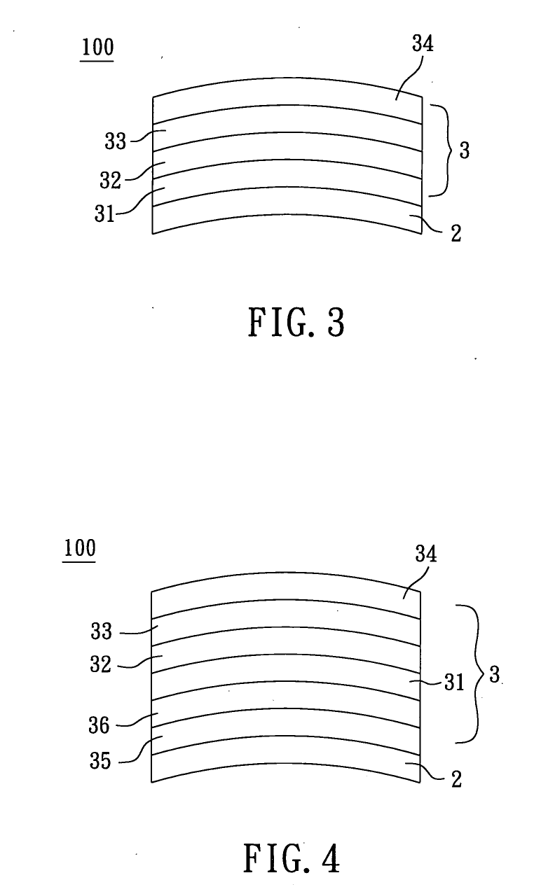

FIG. 3 illustrates a second preferred embodiment of this invention. In this embodiment, the first optical unit 3 of the optical material 100 further includes a hard coating 34 formed on the first optical layer 33. The hard coating 34 is made by: (f) modifying the surface of the first optical layer 33, and (g) forming a hard coating 34 of polysiloxane copolymer or polymethacrylic acid copolymer on the first optical layer 33. The process for surface modification includes, for example, coupling agent activation, plasma graft process, and primer process. The formation of the hard coating 34 can be performed before or after the step (d).

FIG. 4 illustrates a third preferred embodiment of this invention. This preferred embodiment differs from the second embodiment in that the first optical unit 3 further includes a second optical layer 35 of a second polymer and a second complex layer 36 interposed between the second optical layer 35 and the base layer 31. The method for making the third preferred embodiment is similar to that for making the second preferred embodiment except that, after the step (c), the method further includes the steps of: (b′) contacting the lower side 312 of the base layer 31 with a second solution containing a monomeric compound of a second polymer such that the monomeric compound of the second polymer penetrates into the base layer 31 so as to form a second penetrated region in the base layer 31 and such that the monomeric compound of the second polymer forms into a second polymerizable layer on the second penetrated region of the base layer 31; and (c′) polymerizing the monomeric compound of the second polymerizable layer and the monomeric compound in the second penetrated region of the base layer 31 so as to form the second penetrated region into the second complex layer 36 and the second polymerizable layer into the second optical layer 35. In addition, in this embodiment, the substrate 2 is formed on the second optical layer 35 opposite to the second complex layer 36 rather than on the base layer 31.

In this embodiment, the second polymer and the second solution are respectively similar to the first polymer and the first solution in the first preferred embodiment. Preferably, the second solution further includes a second dye similar to the first dye of the first preferred embodiment.

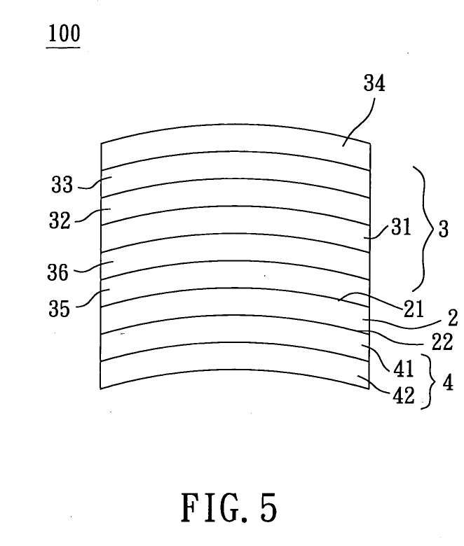

FIG. 5 shows a fourth preferred embodiment of this invention. This embodiment differs from the third preferred embodiment in that the optical material 100 further includes a second optical unit 4 formed on the lower surface 22 of the substrate 2. The second optical unit 4 includes a third optical layer 42 of a third polymer and a third complex layer 41 disposed between the substrate 2 and the third optical layer 42.

The method for making the fourth preferred embodiment is similar to that for making the third preferred embodiment except that, after the step (d), the method further includes the steps of: (h) contacting the lower surface 22 of the substrate 2 with a third solution containing a monomeric compound of a third polymer such that the monomeric compound of the third polymer penetrates into the substrate 2 so as to form a third penetrated region in the substrate 2 and such that the monomeric compound of the third polymer forms into a third polymerizable layer on the third penetrated region of the substrate 2; and (i) polymerizing the monomeric compound of the third polymerizable layer and the monomeric compound in the third penetrated region of the substrate 2 so as to form the third penetrated region into the third complex layer 41 and the third polymerizable layer into the third optical layer 42.

In this embodiment, the third polymer and the third solution are respectively similar to the first polymer and the first solution in the first preferred embodiment. Preferably, the third solution further includes a third dye similar to the first dye of the first preferred embodiment.

The layer thicknesses of the substrate 2 and each of the layers of the optical units 3, 4, are not limited and vary based on actual requirements. In an embodiment of this invention, for example, the first optical unit 3 has a layer thickness ranging from 0.2 mm to 2.0 mm, and more preferably, from 0.5 mm to 0.8 mm.

In addition, the penetration extent of each of the dyes into the respective one of the complex layers 32, 36, 41 can be controlled by controlling the contacting time and swelling degree of the base layer 31 and the substrate 2.

### EXAMPLES

### Example 1

An optical material 100 shown in FIG. 2 was made by: (1) disposing a PET polarizer film (available from R&S Company, Japan) serving as a base layer 31 in a mold; (2) pouring a first solution on an upper side 311 of the PET polarizer film 31 at a pouring rate of 10 mm/sec so as to form a solution layer of a layer thickness of about 10 μm on the upper side 311 of the PET polarizer film 31, and allowing the solution layer to remain on the upper side 311 of the PET polarizer film 31 for 10 minutes to thereby form a first penetrated region in the PET polarizer film 31 and a first polymerizable layer on the first penetrated region, the first solution having 25 wt % of solid content and 20 CPS of viscosity and being prepared by dissolving 1000 g of polyurethane (PU) primer (having a molecular weight of 300 and available from SDC Coating Inc., USA) and 50 g of sea green blue dye (Reversacoll™ photochromic dyes, available from James Robison Company, GB) in 100 ml THF (available from Fisher Scientific Company, USA); (3) heating the first penetrated region and the first polymerizable layer at 80° C. for 60 minutes so as to form the first penetrated region into a first complex layer 32 and the first polymerizable layer into a first optical layer 33, thereby obtaining a 0.7 mm first optical unit 3 including the base layer 31, the first complex layer 32, and the first optical layer 33; (4) disposing the first optical unit 3 thus formed in a preforming machine and pressing it to a desired shape at 120° C. and 10 atm; and (5) placing the shaped first optical unit 3 in a mold of an injection molding device, and injecting 200 g of polycarbonate/polyester alloy (xylex) as a substrate polymer into the mold under a lower side 312 of the base layer 31 so as to obtain the optical material 100 containing a substrate 2 and the first optical unit 3.

A salt test and a weather test were conducted on the optical material 100 thus formed. The salt test was performed as follows: placing the optical material 100 thus formed in a 10 wt % salt solution (e.g., a solution of sodium chloride) at 95° C. for one hour; taking out the optical material 100 and cutting the optical material 100 to form 100 cells using a cross hatch cutter at 45° cutting angle; attaching a 3M Scotch tape on the first optical layer 33 of the optical material 100; removing the 3M Scotch tape from the optical material 100; and observing delamination phenomenon of each of the cells of the optical material 100. Moreover, the weather test was performed as follows: placing the optical material 100 which had been cut into 100 cells using the cross hatch cutter in 20 liters of 5 wt % salt solution (e.g., a solution of sodium chloride) in the salt spray device at 40° C. and 95% relative moisture for 48 hours; and taking out the optical material 100 to observe the delamination phenomenon. If no delamination was found, 3M Scotch tape was then attached to the optical material 100 and was then removed therefrom to observe delamination phenomenon of each of the cells of the optical material 100.

The results show that no delamination phenomenon of each of the cells of the first preferred embodiment of the optical material 100 was found after the tests.

### Example 2

The method for making the second preferred embodiment of the optical material 100 shown in FIG. 3 was similar to that for making Example 1 except that the polarizer film was a polycarbonate (PC) sandwich polarizer plate (composed of PC film/PVA polarizer film/PC film and available from Mitsubishi Company, Japan) and that, after the step (5), the method further includes the steps of: (6) applying a coupling agent (N-(2-aminoethyl)-3-aminopropyltrimethoxy-silane available from United Chemical Technologies Company) to the first optical layer 33 so as to modify the surface of the first optical layer 33; and (7) applying a solution containing siloxane monomers (available from SDC Coating Inc.) to the modified first optical layer 33 at 4 mm/sec, and polymerizing the siloxane monomers at 120° C. for 3 hours so as to form a hard coating 34 on the first optical layer 33.

The optical material 100 thus formed was subjected to the salt test and the weather test, in which a 3M Scotch tape was attached onto the hard coating 34. Similarly, the results show that no delamination phenomenon of each of the cells of the second preferred embodiment of the optical material 100 was found.

### Example 3

The method for making the third preferred embodiment of the optical material 100 shown in FIG. 4 was similar to that for making Example 2 except that, before the step (4), the steps (2) and (3) were repeated on the lower side 312 of the polycarbonate (PC) sandwich polarizer plate 31 so as to form a second complex layer 36 on the lower side 312 of the polycarbonate (PC) sandwich polarizer plate 31 and a second optical layer 35 on the second complex layer 36 opposite to the polycarbonate (PC) sandwich polarizer plate 31. The polycarbonate (PC) sandwich polarizer plate 31, the first complex layer 32, the first optical layer 33, the second optical layer 35, the second complex layer 36, and the hard coating 34 constitute a first optical unit 3. Moreover, in this embodiment, the substrate 2 is formed on the second optical layer 35 opposite to the second complex layer 36 rather than on the lower side 312 of the polycarbonate (PC) sandwich polarizer plate 31.

The optical material 100 thus formed was subjected to the salt test and the weather test, in which a 3M Scotch tape was attached onto the hard coating 34. Similarly, the results show that no delamination phenomenon of each of the cells of the third preferred embodiment of the optical material 100 was found.

### Example 4

The method for making the fourth preferred embodiment of the optical material 100 shown in FIG. 5 was similar to that for making Example 3 except that, after the step (5), the steps (2) and (3) were repeated on one side 22 of the substrate 2 opposite to the first optical unit 3 so as to form a third complex layer 41 on the substrate 2 and a third optical layer 42 on the third complex layer 41. The third complex layer 41 and the third optical layer 42 constitute a second optical unit 4.

The optical material 100 thus formed was subjected to the salt test and the weather test, in which a 3M Scotch tape was attached onto the hard coating 34. Similarly, the results show that no delamination phenomenon of each of the cells of the fourth preferred embodiment of the optical material 100 was found.

According to the present invention, the complex layers 32, 36, and 41 provide improved bonding strength to the layers adhered thereto, and the optical material 100 with the complex layers 32, 36, and 41 can be easily made by the method of this invention, thereby preventing the delamination phenomenon and reducing production costs.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. An optical material comprising:
a substrate having an upper surface and a lower surface; and
a first optical unit formed on said upper surface of said substrate and including a base layer of a base polymer, a first optical layer of a first polymer, and a first complex layer disposed between said base layer and said first optical layer and formed by the following steps:
contacting one side of said base layer with a first solution containing a monomeric compound of said first polymer such that said monomeric compound of said first polymer penetrates into said base layer so as to form a first penetrated region in said base layer and such that said monomeric compound of said first polymer forms into a first polymerizable layer on said first penetrated region of said base layer, and
polymerizing said monomeric compound of said first polymerizable layer and said monomeric compound in said first penetrated region of said base layer so as to form said first penetrated region into said first complex layer and said first polymerizable layer into said first optical layer.

2. The optical material of claim 1, wherein said first optical unit further includes a second optical layer of a second polymer, and a second complex layer interposed between said second optical layer and said base layer, said second complex layer being formed by the following steps:
contacting the other side of said base layer with a second solution containing a monomeric compound of said second polymer such that said monomeric compound of said second polymer penetrates into said base layer so as to form a second penetrated region in said base layer and such that said monomeric compound of said second polymer forms into a second polymerizable layer on said second penetrated region of said base layer, and
polymerizing said monomeric compound of said second polymerizable layer and said monomeric compound in said second penetrated region of said base layer so as to form said second penetrated region into said second complex layer and said second polymerizable layer into said second optical layer.

3. The optical material of claim 2, wherein said substrate is made of a substrate polymer, said optical material further comprising a second optical unit formed on said lower surface of said substrate and including a third optical layer of a third polymer, and a third complex layer disposed between said substrate and said third optical layer, said third complex layer being formed by the following steps:
contacting said lower surface of said substrate with a third solution containing a monomeric compound of said third polymer such that said monomeric compound of said third polymer penetrates into said substrate so as to form a third penetrated region in said substrate and such that said monomeric compound of said third polymer forms into a third polymerizable layer on said third penetrated region of said substrate, and
polymerizing said monomeric compound of said third polymerizable layer and said monomeric compound in said third penetrated region of said substrate so as to form said third penetrated region into said third complex layer and said third polymerizable layer into said third optical layer.

4. The optical material of claim 1, further comprising a hard coating formed on said first optical layer opposite to said first complex layer.

5. The optical material of claim 2, further comprising a hard coating formed on said first optical layer opposite to said first complex layer.

6. The optical material of claim 3, further comprising a hard coating formed on said first optical layer opposite to said first complex layer.

7. The optical material of claim 3, wherein said first solution further contains a first dye, said second solution further containing a second dye, said third solution further containing a third dye, each of said first dye, said second dye, and said third dye being one of a photochromic dye and a photo-absorbing dye.

8. The optical material of claim 3, wherein said substrate polymer is selected from the group consisting of polycarbonate, polymethylmethacrylate, polysulfone, polystyrene, polyurethane, m-cycloolefin copolymer, transparent nylon, allyl methacrylate, diethylene glycol bis allylcarbonate, polycarbonate/polyester alloy, and a resin having a refractive index greater than 1.56.

9. The optical material of claim 3, wherein said base layer exhibits polarizing property and is selected from the group consisting of polyvinyl alcohol, polyethylene terephthalate, polyester, polyacrylate, polycarbonate, polyurethane, cellulose ester, cycloolefin copolymer, polycarbonate/polyester alloy, and combinations thereof.

10. The optical material of claim 3, wherein said first polymer, said second polymer, and said third polymer are independently selected from the group consisting of ethylene glycol bismethacrylate polymer, ethoxylated phenol bismethacrylate polymer, urethane acrylate polymer, polythiourethane polymer, cellulose acetate butyrate, styrene polymer, polyurethane, copoly(styrene-methyl methacrylate) polymer, and combinations thereof.

11. The optical material of claim 7, wherein each of said first polymer, said second polymer, and said third polymer contains from 0 to 15 wt % of the respective one of said first dye, said second dye, and said third dye.

12. A method for making an optical material, comprising the steps of:
(a) providing a base layer made of a base polymer and having an upper side and a lower side;
(b) contacting the upper side of the base layer with a first solution containing a monomeric compound of a first polymer such that the monomeric compound of the first polymer penetrates into the base layer so as to form a first penetrated region in the base layer and such that the monomeric compound of the first polymer forms into a first polymerizable layer on the first penetrated region of the base layer; and
(c) polymerizing the monomeric compound of the first polymerizable layer and the monomeric compound in the first penetrated region of the base layer so as to form the first penetrated region into a first complex layer and the first polymerizable layer into a first optical layer.

13. The method of claim 12, wherein, in step (c), the first complex layer and the first optical layer constitute a first optical unit, said method further comprising a step of (d) bonding a substrate to the first optical unit.

14. The method of claim 13, further comprising a step of (e) shaping the first optical unit into a desired shape before the bonding step (d).

15. The method of claim 13, further comprising a step of (f) forming a hard coating on the first optical layer after the step (c).

16. The method of claim 12, further comprising the steps of:
(b′) contacting the lower side of the base layer with a second solution containing a monomeric compound of a second polymer such that the monomeric compound of the second polymer penetrates into the base layer so as to form a second penetrated region in the base layer and such that the monomeric compound of the second polymer forms into a second polymerizable layer on the second penetrated region of the base layer;
(c′) polymerizing the monomeric compound of the second polymerizable layer and the monomeric compound in the second penetrated region of the base layer so as to form the second penetrated region into a second complex layer and the second polymerizable layer into a second optical layer to thereby obtain a first optical unit; and
(d′) bonding one side of a substrate of a substrate polymer to the first optical unit.

17. The method of claim 16, further comprising the steps of:
(g) contacting the other side of the substrate opposite to the first optical unit with a third solution containing a monomeric compound of a third polymer such that the monomeric compound of the third polymer penetrates into the substrate so as to form a third penetrated region in the substrate and such that the monomeric compound of the third polymer forms into a third polymerizable layer on the third penetrated region of the substrate; and
(h) polymerizing the monomeric compound of the third polymerizable layer and the monomeric compound in the third penetrated region of the substrate so as to form the third penetrated region into a third complex layer and the third polymerizable layer into a third optical layer.

18. The method of claim 16, further comprising a step of (i) forming a hard coating on the first optical layer after the step (c).

19. The method of claim 17, wherein each of the first solution, the second solution, and the third solution has a viscosity ranging from 1 CPS to 150 CPS.

20. The method of claim 12, wherein the first solution has a solid content less than 70%.

21. The method of claim 17, wherein the first solution further contains a first dye, the second solution further containing a second dye, the third solution further containing a third dye, each of the first dye, the second dye, and the third dye having a molecular weight less than 5000, and being one of a photochromic dye and a photo-absorbing dye.

22. The method of claim 17, wherein the polymerization of the monomeric compounds of the first, second, and third polymers is conducted by irradiating with ultraviolet light.
